(19) United States
(12) Patent Application Publication
(10) Pub. No.: US 2011/0032267 A1
(43) Pub. Date: Feb. 10, 2011

(54) METHOD FOR INCREASING FRAME CONTRAST RATIO

(75) Inventors: Chao-Chinge Chen, Taipei County (TW); Pei-Tang Su, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMTRAN TECHNOLOGY CO. LTD, Taipei County (TW)

(21) Appl. No.: 12/573,146

(22) Filed: Oct. 4, 2009

(30) Foreign Application Priority Data
Aug. 5, 2009 (TW) 98126380

(51) Int. Cl. G09G 5/10

(52) U.S. Cl. 345/589

(57) ABSTRACT

A method for increasing a frame contrast ratio is suitable for a liquid crystal display (LCD) having a direct-type light emitting diode (LED) backlight module. The method includes establishing a local dimming demo mode in an on-screen-display (OSD) menu of the LCD, so as to determine to turn on or turn off a local dimming control function. Besides, according to this method, when the local dimming demo mode is turned on, the local dimming control function is continuously and repeatedly turned on or turned off in the direct-type LED backlight module in a time-division manner based on image contents in the whole frame of the LCD, so as to increase the frame contrast ratio of the LCD.

### CROSS-REFERENCE TO RELATED APPLICATION

This application claims the priority benefit of Taiwan application serial no. 98126380, filed on Aug. 5, 2009. The entirety of the above-mentioned patent application is hereby incorporated by reference herein and made a part of specification.

### BACKGROUND OF THE INVENTION

1. Field of the Invention

The invention relates to a method for increasing frame quality. More particularly, the invention relates to a method for increasing a frame contrast ratio.

2. Description of Related Art

In recent years, portable electronic products and flat panel displays have been developed along with the advance in semiconductor technology. Among various flat panel displays, liquid crystal displays (LCDs) characterized by low-voltage operation, non-radiation, light weight, and compactness have become mainstream of display products.

In general, the LCD is not equipped with a self-luminance function, and thus a backlight module (i.e. a direct-type backlight module) is required to be disposed underneath an LCD panel, so as to supply a backlight source to the LCD panel. A conventional backlight module can be roughly classified into two types, i.e. a cold cathode fluorescent lamp (CCFL) backlight module and a light emitting diode (LED) backlight module. Since the LED backlight module is capable of improving color gamut of the LCD, panel manufacturers prefer to employ the LED backlight module in replacement of the CCFL backlight module.

Here, a direct-type LED backlight module is taken as an example. In order to increase a frame contrast ratio, the whole frame of the LCD panel can be divided into M*N blocks, and luminance of the backlight module corresponding to each of the blocks is adjusted according to image contents of each of the blocks. Normally, said technology is the so-called local dimming technology, which refers to a mechanism for adjusting luminance of partitions on the spatial axis.

### SUMMARY OF THE INVENTION

The invention is directed to a method for increasing a frame contrast ratio, and the method is suitable for an LCD having a direct-type LED backlight module. Besides, the method includes establishing a local dimming demo mode in an on-screen-display (OSD) menu of the LCD, so as to turn on or turn off a local dimming control function. Additionally, according to this method, when the local dimming demo mode is turned on, the local dimming control function is turned on or turned off continuously and repeatedly in the direct-type LED backlight module in a time-division manner based on image contents in the whole frame of the LCD, so as to increase the frame contrast ratio of the LCD.

According to an exemplary embodiment of the invention, the local dimming demo mode is determined to be turned on or turned off according to a user command.

According to an exemplary embodiment of the invention, when the local dimming demo mode is turned off, the local dimming control function in the direct-type LED backlight module ceases to be turned on or turned off continuously and repeatedly.

According to an exemplary embodiment of the invention, the local dimming control function is turned on or turned off in every other predetermined time period.

Based on the above and on the premise that the LCD is equipped with the direct-type LED backlight module, conducting the method for increasing the frame contrast ratio in this invention can demonstrate the local dimming technology by applying the mechanism for adjusting luminance of partitions on the time axis, given that the LCD or the frame thereof is not required to be divided. Thereby, the local dimming control function can be turned on or turned off by turning on the local dimming demo mode in the OSD menu of the LCD, such that a user is able to perceive the improvement as a whole in frame quality of the LCD when the local dimming technology is applied.

It should be understood that the above descriptions and the following embodiments are merely exemplary and explanatory and do not limit the scope of the claimed invention.

### BRIEF DESCRIPTION OF THE DRAWINGS

The accompanying drawings are included to provide a further understanding of the invention and are incorporated in and constitute parts of this specification. The drawings illustrate embodiments of the invention and, together with the descriptions, serve to explain the principles of the invention.

FIG. 1 is a flowchart illustrating a method for increasing a frame contrast ratio according to an exemplary embodiment of the invention.

FIG. 2 is a schematic diagram of turning on or turning off a local dimming control function according to an exemplary embodiment of the invention.

### DESCRIPTION OF EMBODIMENTS

Reference will now be made in detail to the exemplary embodiments of the invention, examples of which are illustrated in the accompanying drawings. Besides, if applicable, identical or similar reference numerals of devices/components represent identical or similar parts.

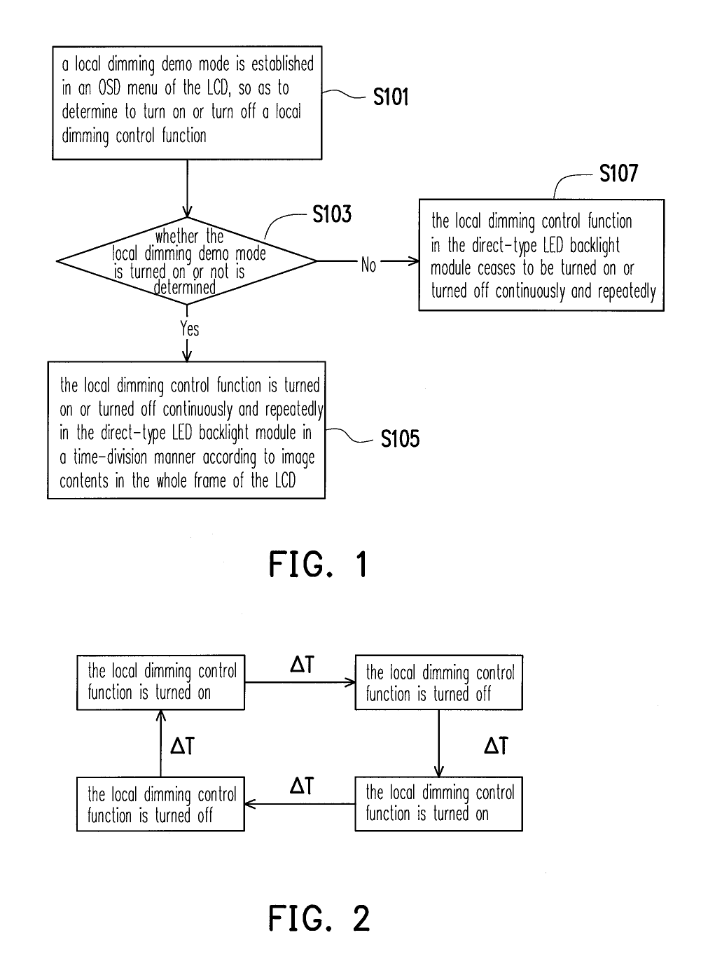

FIG. 1 is a flowchart illustrating a method for increasing a frame contrast ratio according to an exemplary embodiment of the invention. As shown in FIG. 1, the method for increasing the frame contrast ratio according to this embodiment is suitable for an LCD having a direct-type LED backlight module. The method includes following steps. First, a local dimming demo mode is established in an OSD menu of the LCD, so as to determine to turn on or turn off a local dimming control function (step S101). Next, whether the local dimming demo mode is turned on or not is determined (step S103).

According to this embodiment, the local dimming demo mode is determined to be turned on or turned off according to a user command. For instance, when a user intends to turn on or turn off the local dimming demo mode in the OSD menu of the LCD, the user can use a remoter or directly press a function button configured on a side portion of the LCD so as to initiate the OSD menu popup of the LCD. Thus, the user can determine whether to turn on or turn off the local dimming control function merely by entering the local dimming demo mode in the OSD menu with use of a guiding cursor.

When the user decides to turn on the local dimming demo mode, i.e. the local dimming demo mode is determined to be turned on in step S103, the local dimming control function is turned on or turned off continuously and repeatedly in the direct-type LED backlight module in a time-division manner according to image contents in the whole frame of the LCD, so as to increase the contrast ratio of frames on the LCD.

In this embodiment, when the local dimming demo mode is turned on, images can be normally displayed on the LCD at first. Thereafter, after a predetermined time period ΔT (including but not limited to three seconds, for example), the local dimming control function is turned on. After another predetermined time period ΔT, the local dimming control function is turned off. The aforesaid steps are repeated until the local dimming demo mode is turned off, as indicated in FIG. 2.

On the other hand, when the user decides to turn off the local dimming demo mode, i.e. the local dimming demo mode is determined to be turned off in step S103, the local dimming control function in the direct-type LED backlight module ceases to be turned on or turned off continuously and repeatedly (step S107).

In light of the foregoing and on the premise that the LCD is equipped with the direct-type LED backlight module, conducting the method for increasing the frame contrast ratio in this invention can demonstrate the local dimming technology by applying the mechanism for adjusting luminance of partitions on the time axis, given that the LCD or the frame thereof is not required to be divided. Thereby, the local dimming control function can be determined to be turned on or turned off by turning on the local dimming demo mode in the OSD menu of the LCD, such that a user is able to perceive the improvement as a whole in frame quality of the LCD when the local dimming technology is applied.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for increasing a frame contrast ratio suitable for a liquid crystal display having a direct-type light emitting diode backlight module, the method comprising:
establishing a local dimming demo mode in an on-screen-display menu of the liquid crystal display to determine whether a local dimming control function is turned on or turned off; and
continuously and repeatedly turning on or turning off the local dimming control function in the direct-type light emitting diode backlight module in a time-division manner according to image contents in the whole frame of the liquid crystal display when the local dimming demo mode is turned on, so as to increase the contrast ratio of the frame of the liquid crystal display.

2. The method for increasing the frame contrast ratio as claimed in claim 1, wherein the local dimming demo mode is determined to be turned on or turned off according to a user command.

3. The method for increasing the frame contrast ratio as claimed in claim 2, wherein the local dimming control function in the direct-type light emitting diode backlight module ceases to be turned on or turned off continuously and repeatedly when the local dimming demo mode is turned off.

4. The method for increasing the frame contrast ratio as claimed in claim 1, wherein the local dimming control function is turned on or turned off in every other predetermined time period.
